(19) United States
(12) Patent Application Publication
(10) Pub. No.: US 2020/0266556 A1
(43) Pub. Date: Aug. 20, 2020

(54) CONNECTOR TERMINAL AND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shunya TAKEUCHI, Mie (JP); Hajime KAWASE, Mie (JP); Masaaki TABATA, Mie (JP); Yasuo OMORI, Mie (JP); Teruo HARA, Mie (JP); Hisashi KOJIMA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/757,943

(22) PCT Filed: Oct. 17, 2018
(86) PCT No.: PCT/JP2018/038613

§ 371 Date: Apr. 21, 2020

(30) Foreign Application Priority Data
Oct. 24, 2017 (JP) 2017-205197

(51) Int. Cl. H01R 4/50; H01R 13/432

(52) U.S. Cl. CPC H01R 4/5083; H01R 13/432

(57) ABSTRACT

A connector terminal that is to be attached to a connector housing includes: a terminal main body unit including a wire connection section that is to be electrically connected to a core wire of a wire; and a cover unit configured to be attached to the wire connection section, and to cover the wire connection section. The wire connection section includes a locking portion configured to lock the cover unit. The cover unit includes an engagement portion configured to be engaged with the locking portion so as to lock the cover unit to the wire connection section, and a pressing portion configured to, in a state in which the engagement portion is engaged with the locking portion, sandwich and press the core wire of the wire between the pressing portion and the wire connection section.

### TECHNICAL FIELD

A technique disclosed in the present specification relates to a connector terminal and a connector including the connector terminal, and more particularly relates to a technique for electrically connecting the core wire of a wire to a connector terminal.

### BACKGROUND ART

Conventionally, the technique described in Patent Document 1, for example, is known as the above-described connection technique. Patent Document 1 discloses a technique in which a connector terminal (terminal) includes a wire barrel portion and an insulation barrel portion, the wire barrel portion is crimped to the core wire of a covered wire, and the insulation barrel portion is crimped to the covering of the covered wire.

### CITATION LIST

### Patent Documents

Patent Document 1: JP 2013-62103A

### SUMMARY OF INVENTION

### Technical Problem

However, Patent Document 1 above requires a process for crimping each of the barrel portions using a crimping jig in a connection operation of connecting the wire to the connector terminal. For this reason, there has been demand for a connector terminal that can further simplify the connection operation of connecting a wire to a connector terminal.

Therefore, the technique disclosed in the present specification provides a connector terminal that can further simplify the connection operation of connecting a wire to a connector terminal, and a connector including the connector terminal.

### Solution to Problem

A connector terminal disclosed in the present specification is a connector terminal that is to be attached to a connector housing, the connector terminal including: a terminal main body unit including a wire connection section that is to be electrically connected to a core wire of a wire; and a cover unit configured to be attached to the wire connection section, and to cover the wire connection section, wherein the wire connection section includes a locking portion configured to lock the cover unit, and the cover unit includes an engagement portion configured to be engaged with the locking portion so as to lock the cover unit to the wire connection section, and a pressing portion configured to, in a state in which the engagement portion is engaged with the locking portion, sandwich and press the core wire of the wire between the pressing portion and the wire connection section.

With the present configuration, in a state in which the engagement portion is engaged with the locking portion, the pressing portion of the cover unit sandwiches and presses the core wire of the wire between the pressing portion and the wire connection section. At that time, the core wire of the wire is pressed against the wire connection section by the pressing portion, and thus, the core wire of the wire can be electrically connected to the wire connection section. Accordingly, the core wire of the wire can be electrically connected to the connector terminal by simply attaching the cover unit to the wire connection section. Thus, the connection operation of connecting the wire to the connector terminal can be further simplified.

In the above-described connector terminal, the pressing portion may include a pressing protruding part configured to form a protrusion by curving the core wire when the cover unit is attached to the wire connection section, and to press the protrusion against the wire connection section.

With the present configuration, the protrusion of the core wire that has been curved by the pressing protruding part is pressed against and connected to the wire connection section. At that time, the pressing force can be focused onto the protrusion of the core wire, and thus, the connection between the core wire and the wire connection section can be made firmer.

In the above-described connector terminal, the wire connection section may include a bottom portion, and a pair of wall portions that are opposed to each other standing upright from both edges of the bottom portion, and the pressing portion may sandwich and press the core wire between the pressing portion and the bottom portion of the wire connection section.

With the present configuration, the core wire is sandwiched and pressed between the pressing portion and the bottom portion of the wire connection section. Accordingly, the operation of pressing the core wire and connecting the core wire to the wire connection section can be easily performed through the operation of attaching the cover unit to the wire connection section from above.

In the above-described connector terminal, the bottom portion of the wire connection section may include, at a position thereof opposed to the pressing portion of the cover unit, a raised part that is raised to the pressing portion side. With the present configuration, the core wire is sandwiched and pressed between the pressing portion of the cover unit and the raised part of the wire connection section. Accordingly, the connection between the core wire and the wire connection section can be made more reliable and firmer.

In the above-described connector terminal, each of the pair of wall portions may include a holding portion configured to hold the core wire when the cover unit is attached to the wire connection section.

With the present configuration, when the cover unit is attached to the wire connection section and the core wire is pressed against the wire connection section, the core wire is held by the holding portions. Accordingly, the pressing operation can be stabilized.

In the above-described connector terminal, the holding portions may be formed between the pair of wall portions at positions that are displaced relative to each other.

With the present configuration, the core wire is held by the holding portions at different positions. Accordingly, the core wire can be stably held by the holding portions.

In the above-described connector terminal, the holding portions may each have a plate shape including a corner part, and the holding portions may hold the core wire with the corner parts.

With the present configuration, the core wire is held by the corner parts of the holding portions, and therefore, the core wire can be more firmly held.

In the above-described connector terminal, the cover unit may include a deformation restricting portion configured to restrict deformation of the pressing protruding part when the pressing protruding part curves the core wire. With the present configuration, deformation of the pressing protruding part when the pressing protruding part curves the core wire can be suppressed by the deformation restricting portion. Thus, the pressing operation of the core wire by the pressing protruding part can be reliably performed.

In the above-described connector terminal, the wire connection section may include a check portion for checking electrical connection between the wire connection section and the core wire, and the cover unit may include a window portion for exposing the check portion.

With the present configuration, checking of the electrical connection between the wire connection section and the core wire can be easily performed via the window portion of the cover unit.

In the above-described connector terminal, the terminal main body unit may include a terminal connection section that is formed as a single piece with the wire connection section, and that is to be connected to a counterpart connector terminal, and, in a state in which the cover unit is attached to the wire connection section, the wire connection section may include, between the terminal connection section and the cover unit, an opening for detecting the presence or absence of the core wire.

With the present configuration, in a state in which the cover unit is attached to the wire connection section, whether or not the core wire, i.e., the wire, is inserted to a predetermined position of the wire connection section can be checked via the opening.

In the above-described connector terminal, the wire may be covered wire including a covering portion that covers the core wire, and at least one of the wire connection section and the cover unit may include a clamping portion configured to clamp the covering portion.

With the present configuration, the wire, including the covering portion, can be disposed in the wire connection section to which the cover unit is attached.

A connector disclosed in the present specification includes: any one of the above-described connector terminals; and a connector housing into which the connector terminal is to be inserted.

The present configuration includes a connector terminal that can further simplify the connection operation of connecting the wire. This leads to simplification of the manufacturing operation of the connector.

The above-described connector may include a rear holder configured to be attached to the connector housing, and including a wire insertion port into which the wire is to be inserted, wherein the rear holder includes a wire insertion hole expanding toward the wire insertion port in a tapered shape.

With the present configuration, the wire insertion hole has a shape expanding toward the wire insertion port in a tapered shape. Accordingly, the operation of inserting the wire into the connector terminal via the rear holder can be facilitated.

### Advantageous Effects of Invention

With the connector terminal disclosed in the present specification, it is possible to further simplify the connection operation of connecting a wire to a connector terminal.

### BRIEF DESCRIPTION OF DRAWINGS

FIG. 1 is a perspective view showing a connector terminal according to an embodiment.

FIG. 2 is a perspective view showing a terminal main body unit of the connector terminal.

FIG. 3 is a plan view of the terminal main body unit.

FIG. 4 is a cross-sectional view of the terminal main body unit as viewed in the direction indicated by the arrows A in FIG. 3.

FIG. 5 is a cross-sectional view of a wire connection section of the terminal main body unit as viewed in the direction indicated by the arrows B in FIG. 4.

FIG. 6 is a perspective view showing a cover unit of the connector terminal.

FIG. 7 is a side view showing the cover unit.

FIG. 8 is a perspective view showing a connector housing of a connector.

FIG. 9 is a plan view of the connector housing.

FIG. 10 is a cross-sectional view of the connector housing including a connector terminal, as viewed in the direction indicated by the arrows C in FIG. 9.

FIG. 11 is a perspective view showing a state in which a rear holder is attached to the connector housing.

FIG. 12 is a plan view showing a state in which the rear holder is attached to the connector housing.

FIG. 13 is a cross-sectional view including a connector terminal and a wire, as viewed in the direction indicated by the arrows D in FIG. 12.

FIG. 14 is a cross-sectional view showing a state in which the cover unit is pressed in FIG. 13.

FIG. 15 is a cross-sectional view of a connector terminal according to another embodiment.

### DESCRIPTION OF EMBODIMENTS

### Embodiment

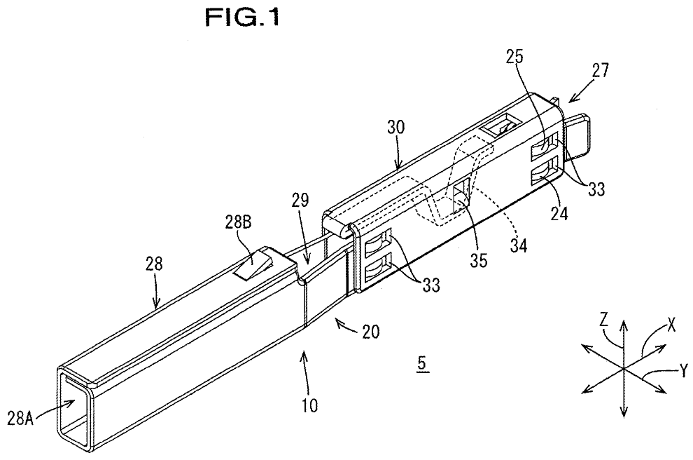

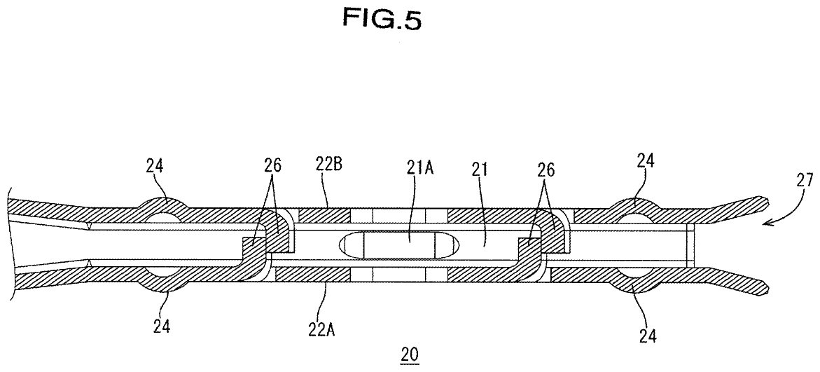

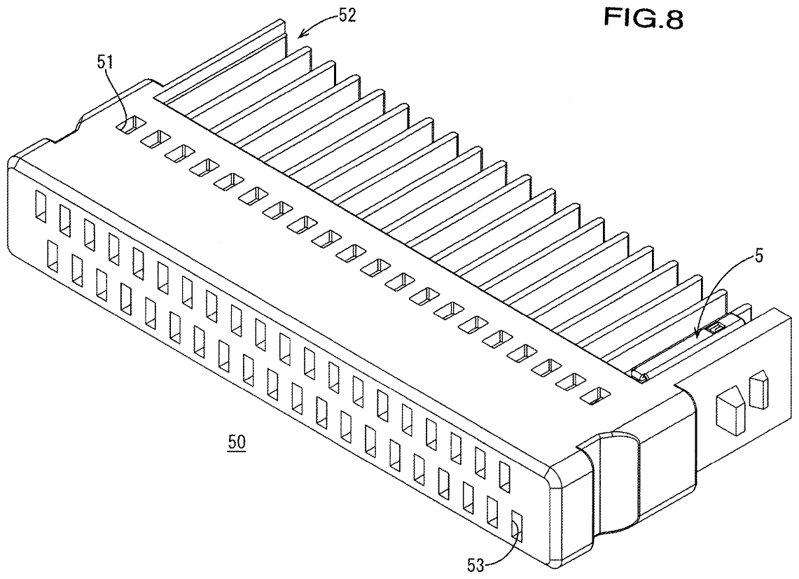

An embodiment will be described with reference to FIGS. 1 to 14. A connector terminal 5 according to the embodiment is to be attached to a connector housing 50 of a connector 100 (see FIG. 8). Note that, in the following, the direction of the arrow X in FIG. 1 is the axial direction of the connector terminal 5, the direction of the arrow Y is the width direction of the connector terminal 5, and the direction of the arrow Z is the vertical direction of the connector terminal 5.

### 1. Configuration of Connector Terminal

The connector terminal 5 according to the embodiment is a female connector terminal, and includes a terminal main body unit 10 and a cover unit 30, as shown in FIG. 1. Note that the connector terminal 5 is not limited to a female connector terminal, and may be a male connector terminal.

### 1-1. Terminal Main Body Unit

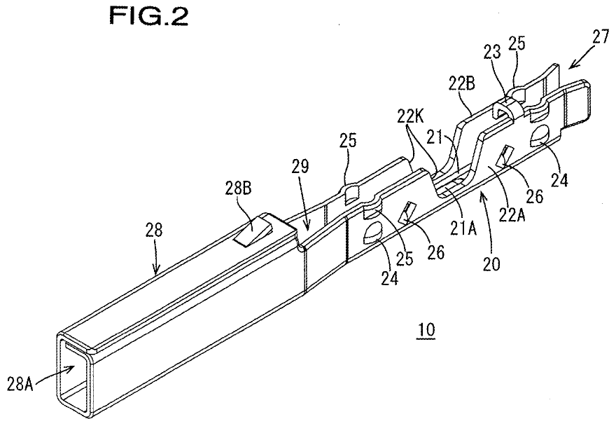

As shown in FIG. 2, the terminal main body unit 10 roughly includes a wire connection section 20 and a terminal connection section 28, and is made of a single metal plate, for example, through punching, bending, pressing, and the like.

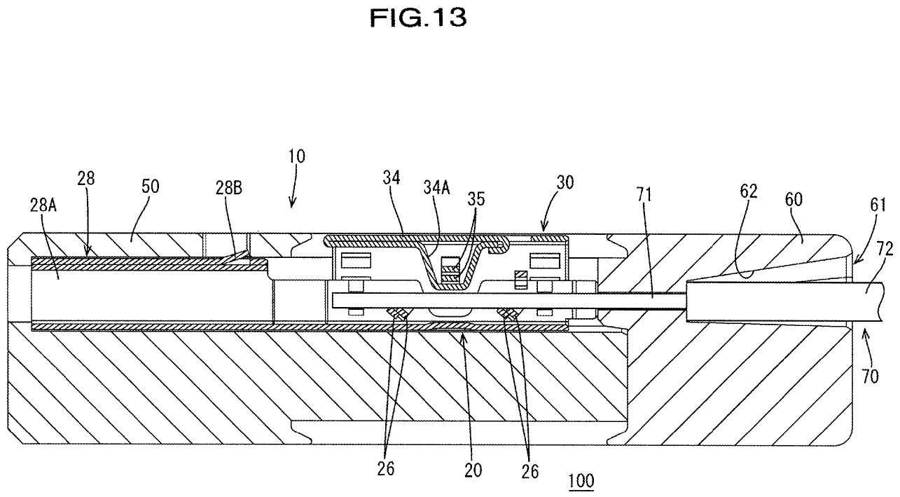

As shown in FIG. 2, the wire connection section 20 includes a bottom portion 21, and a pair of wall portions (22A, 22B) that are opposed to each other standing upright upward from both edges of the bottom portion 21, and the wire connection section 20 is electrically connected to a core wire 71 of a wire 70 (see FIG. 13). The wire 70 is a covered wire including a core wire 71 and a covering portion 72. Due to the relationship with the cover unit 30, the wall portions (22A, 22B) each have a cut-out part 22K formed therein.

The bottom portion 21 includes, at a position thereof opposed to a pressing portion 34, which will be described below, of the cover unit 30, a raised part 21A that is raised to the pressing portion side. The core wire 71 is sandwiched and pressed between the pressing portion 34 of the cover unit 30 and the raised part 21A. Accordingly, the raised part 21A can make the connection between the core wire 71 and the wire connection section 20 more reliable and firmer. Note that the raised part 21A does not need to be provided.

Each of the wall portions (22A, 22B) includes, at two locations thereof, a pair of locking portions (24, 25) that lock the cover unit 30. As shown in FIG. 2, the locking portions (24, 25) are each formed, through pressing, for example, as an arc-shaped protrusion protruding outward of the wall. Note that the shape and the configuration of the locking portions (24, 25) are not limited to those shown in FIG. 2.

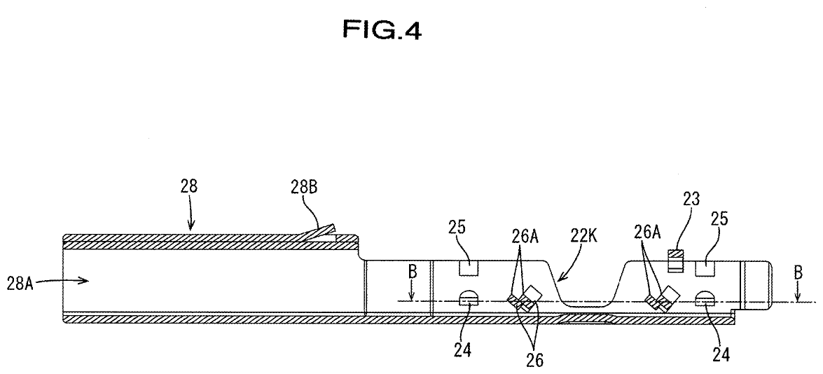

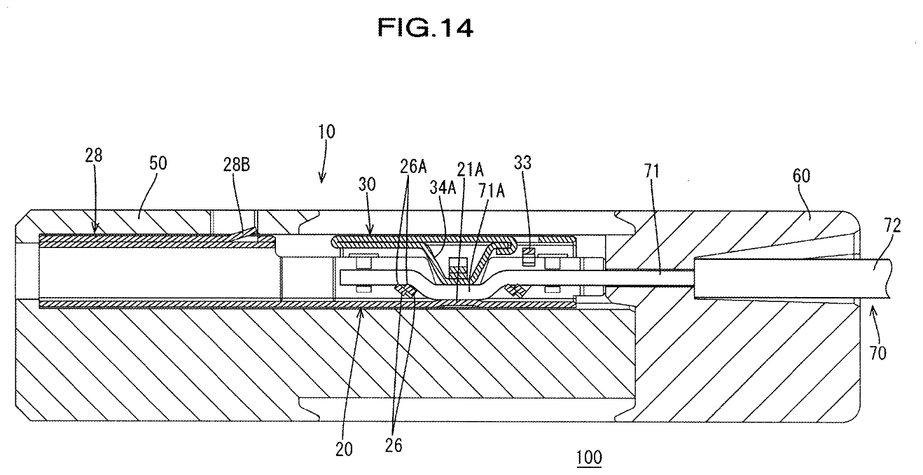

In addition, each of the wall portions (22A, 22B) includes, at two locations thereof, holding portions 26 that hold the core wire 71 when the cover unit 30 is attached to the wire connection section 20. As shown in FIG. 2, the holding portions 26 are each formed as a plate-shaped portion by a part of the wall portion (22A or 22B) protruding inward of the wall through punching, for example. That is, the holding portions 26 each have a plate shape including a corner part 26A, and hold the core wire 71 using the corner parts 26A (see FIGS. 4 and 14). In this manner, in the present embodiment, the hold of the core wire 71 is achieved by the corner parts (edge parts) 26A of the plate-shaped holding portions 26, and therefore, the corner parts 26A bite into the core wire 71, thus making it possible to further firmly hold the core wire 71.

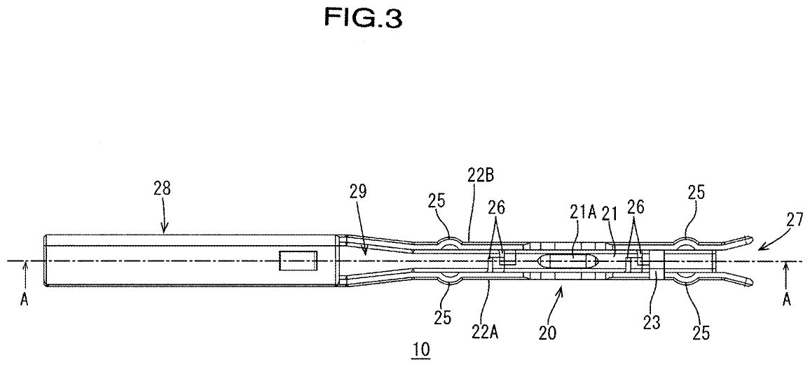

As shown in FIG. 3, the holding portions 26 are formed between the pair of wall portions (22A, 22B) at positions that are displaced relative to each other. That is, between the pair of wall portions (22A, 22B), the core wire 71 is held by the holding portions 26 at different positions. Accordingly, the core wire 71 can be further stably held by the holding portions 26.

In addition, the wire connection section 20 includes a check portion 23 for checking the electrical connection between the wire connection section 20 and the core wire 71. As shown in FIG. 2, the check portion 23 is formed so as to protrude from the wall portion 22A toward the wall portion 22B. The check portion 23 allows the electrical connection (electrical conduction) between the wire connection section 20 and the core wire 71 to be checked easily via a window portion 31A, which will be described below, of the cover unit 30.

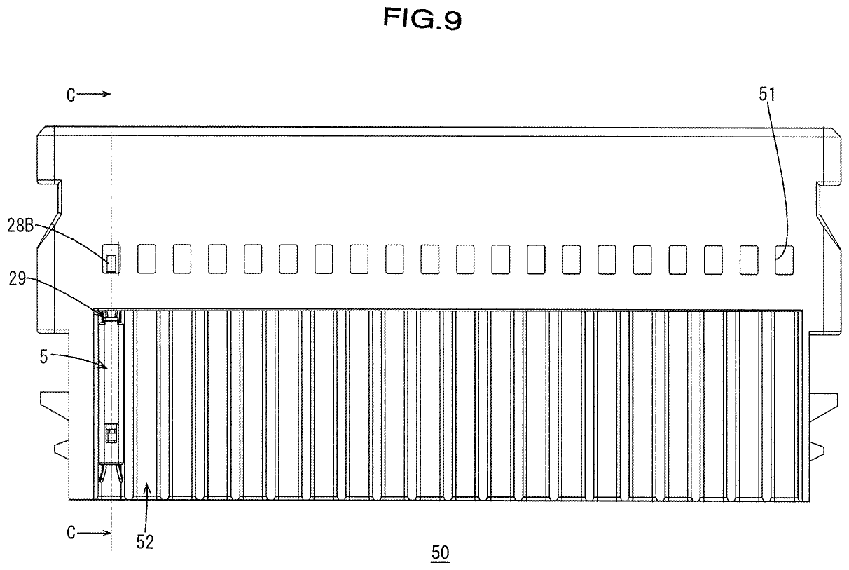

In a state in which the cover unit 30 is attached to the wire connection section 20, the wire connection section 20 includes, between the terminal connection section 28 and the cover unit 30, an opening 29 for detecting the presence or absence of the core wire 71. In a state in which the cover unit 30 is attached to the wire connection section 20, whether or not the core wire 71, i.e., the wire 70, is inserted to a predetermined position of the wire connection section 20 can be checked via the opening 29. Note that, as will be described below, this checking can also be performed after the connector terminal 5 has been inserted into the connector housing 50 (see FIG. 9).

The terminal connection section 28 is formed as a single piece with the wire connection section 20, and is connected to a male connector terminal (not shown) serving as a counterpart connector terminal. The terminal connection section 28 include an insertion hole 28A and a locking projection 28B. A terminal connection section of the male connector terminal is inserted into the insertion hole 28A. The locking projection 28B is engaged with a retaining opening 51 of the connector housing 50, and locks the terminal main body unit 10 (connector terminal 5) to the connector housing 50.

### 1-2. Cover Unit

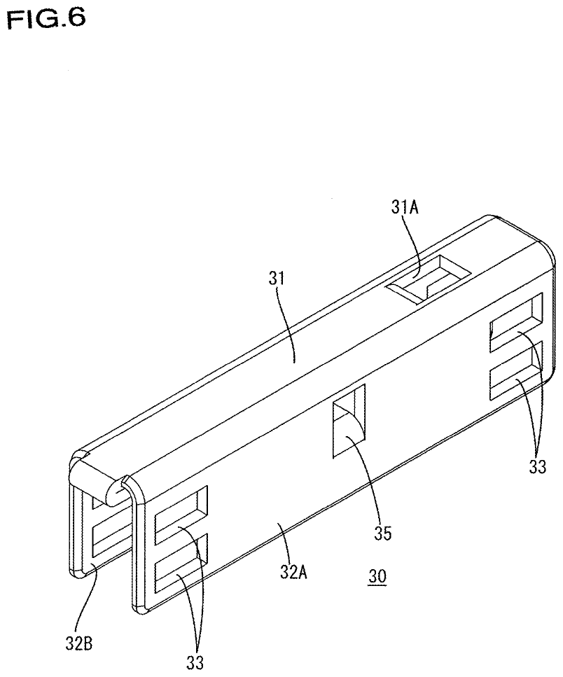

As shown in FIG. 6, the cover unit 30 has a shape including a ceiling portion 31 and a pair of side wall portions (32A, 32B) that are opposed to each other standing upright downward from both edges of the ceiling portion 31, and the cover unit 30 covers the wire connection section 20 from above.

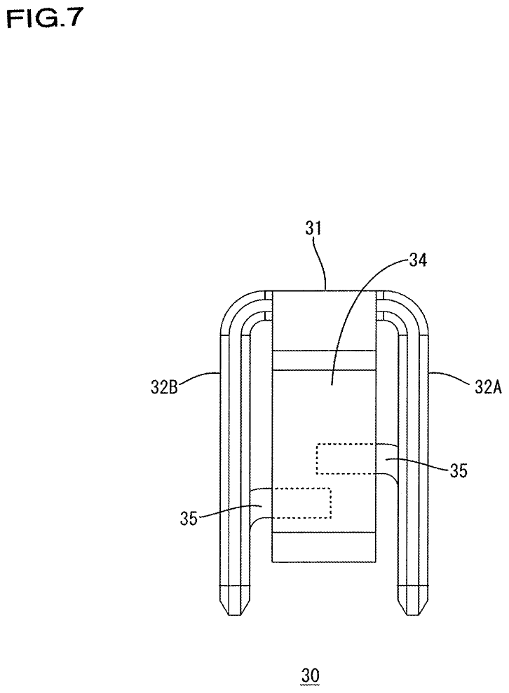

In addition, as shown in FIGS. 6 and 7, the cover unit 30 includes engagement portions 33 and a pressing portion 34, and is made of a single metal plate, for example, through punching, bending, pressing, and the like, as in the case of the terminal main body unit 10.

As shown in FIG. 6, the engagement portions 33 are formed in two upper and lower locations at either end of each of the side wall portions (32A, 32B) in the axial direction (the direction of the arrow X in FIG. 1). That is, four engagement portions 33 in each of the side wall portions (32A, 32B), i.e., a total of eight engagement portions 33, are formed in the cover unit 30. The upper engagement portions 33 are engaged with the upper locking portions 25 of the wire connection section 20, and the lower engagement portions 33 are engaged with the lower locking portions 24 of the wire connection section 20. In the present embodiment, the engagement portions 33 are each formed by a window portion formed through punching. Note that the configuration of the engagement portions 33 is not limited to a window portion.

In a state in which the engagement portions 33 are engaged with the locking portions (24, 25), the pressing portion 34 sandwiches and presses the core wire 71 of the wire 70 between the pressing portion 34 and the wire connection section 20, or more specifically, the raised part 21A formed on the bottom portion 21 of the wire connection section 20.

The pressing portion 34 includes a pressing protruding part 34A formed by bending a metal member extending continuously from the ceiling portion 31 (see FIG. 13, etc). The pressing protruding part 34A forms a protrusion 71A by curving the core wire 71 when the cover unit 30 is attached to the wire connection section 20, and presses the protrusion 71A against the wire connection section 20, or more specifically, the raised part 21A of the wire connection section 20 (see FIG. 14). That is, in the present embodiment, the protrusion 71A of the core wire 71 that has been curved by the pressing protruding part 34A is pressed against and connected to the wire connection section 20. At that time, the pressing force can be focused onto the protrusion 71A of the core wire, and thus, the connection between the core wire 71 and the wire connection section 20 can be made firmer. Note that the shape of the pressing protruding part 34A is not limited to that shown in FIG. 14 and so forth. Also, the pressing protruding part 34A does not need to be provided on the pressing portion 34. That is, the pressing portion 34 may have any shape.

The cover unit 30, or more specifically, the side wall portions (32A, 32B) of the cover unit 30, include deformation restricting portions 35 that restrict deformation of the pressing protruding part 34A when the pressing protruding part 34A curves the core wire 71. As shown in FIG. 6, the deformation restricting portions 35 are formed by punching and bending the side wall portions (32A, 32B), and each have a plate shape (see FIG. 7). Deformation of the pressing protruding part 34A when the pressing protruding part 34A curves the core wire 71 can be suppressed by the deformation restricting portions 35. Accordingly, the pressing operation of the core wire 71 by the pressing protruding part 34A can be reliably performed. Note that the shape of the deformation restricting portions 35 is not limited to a plate shape, and the deformation restricting portions 35 do not need to be provided.

In addition, as shown in FIG. 6, a window portion 31A for exposing the check portion 23 of the wire connection section 20 is formed in the cover unit 30, or more specifically, in the ceiling portion 31 of the cover unit 30.

### 2. Method for Mounting Connector Terminal

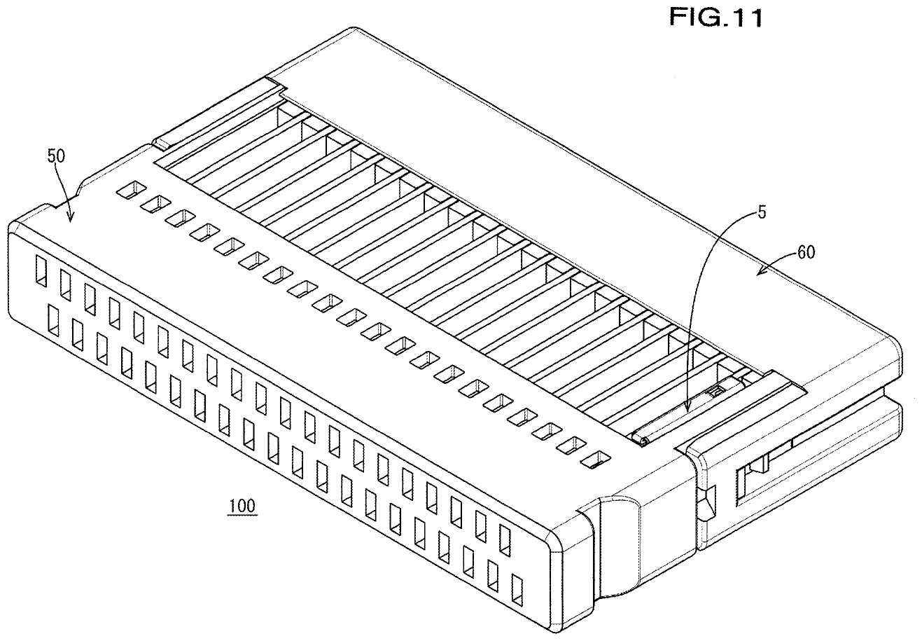

Next, with reference to FIGS. 8 to 14, a method for mounting the connector terminal 5 to the connector 100 will be schematically described. Here, as shown in FIG. 11, the connector 100 includes a connector terminal 5, a connector housing 50 into which the connector terminal 5 is inserted, and a rear holder 60. Although the connector 100 additionally includes a retainer, an outer housing, and so forth, the illustrations and descriptions thereof have been omitted.

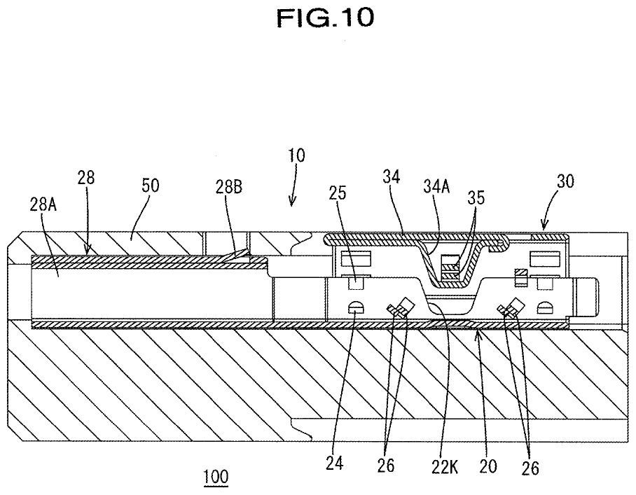

First, as shown in FIGS. 8 and 9, an unengaged connector terminal 5 in which the cover unit 30 is simply placed on the terminal main body unit 10 is inserted into a connector terminal insertion portion 52 of the connector housing 50. At that time, the locking projection 28B of the connector terminal 5 is engaged with a retaining opening 51 of the connector housing 50 so as to lock the connector terminal 5 to the connector housing 50. FIG. 10 shows a cross-sectional view showing the relationship between the connector housing 50 and the connector terminal 5 in this state.

Note that, as shown in FIGS. 8 and 9, the connector housing 50 includes upper and lower rows of a plurality of counterpart connector terminal insertion ports 53, and connector terminal insertion portions 52 respectively corresponding to the counterpart connector terminal insertion ports 53. However, for the sake of convenience of description, FIGS. 8 and 9 show an example in which one connector terminal 5 is inserted into a connector terminal insertion portion 52. The same also applies to the following.

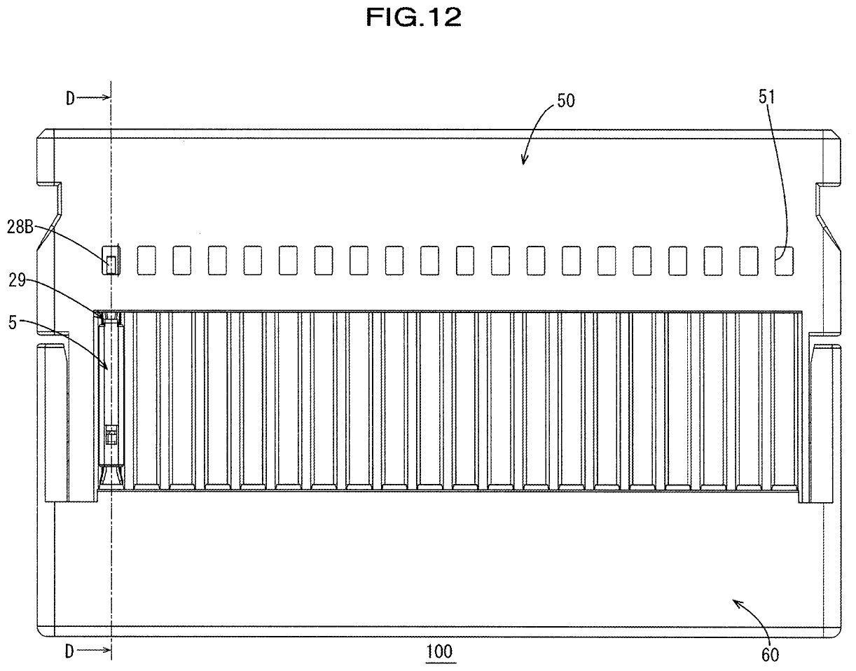

Next, as shown in FIGS. 11 and 12, the rear holder 60 is attached to the connector housing 50 into which the connector terminal 5 is inserted. Thus, the mounting of the connector terminal 5 to the connector 100 is completed.

Furthermore, as shown in FIG. 13, the wire 70 is inserted to a predetermined position of the terminal main body unit 10 of the connector terminal 5 via a wire insertion port 61 and a wire insertion hole 62 of the rear holder 60. At that time, as shown in FIG. 13, the wire insertion hole 62 of the rear holder 60 is formed in a shape expanding toward the wire insertion port 61 in a tapered shape, and, therefore, the operation of inserting the wire 70 into the connector terminal 5 via the rear holder 60 is facilitated.

Then, when the engagement portions 33 of the cover unit 30 are engaged with the locking portions (24, 25) of the terminal main body unit 10 by pressing the cover unit 30 from above, the pressing protruding part 34A deforms (curves) the core wire 71 and presses the core wire 71 against the raised part 21A of the wire connection section 20, as shown in FIG. 14. Thus, the core wire 71 is electrically connected to the wire connection section 20 of the connector terminal 5.

### 3. Effects of the Embodiment

In a state in which the engagement portions 33 of the cover unit 30 are engaged with the locking portions (24, 25) of the terminal main body unit 10, the pressing portion 34 (or more specifically, the pressing protruding part 34A) of the cover unit 30 of the connector terminal 5 in the present embodiment sandwiches and presses the core wire 71 of the wire 70 between the pressing portion 34 and the wire connection section 20. At that time, the core wire 71 of the wire 70 is pressed against the wire connection section 20 by the pressing portion 34, and thus, the core wire 71 of the wire 70 can be electrically connected to the wire connection section 20. Accordingly, the core wire 71 of the wire 70 can be electrically connected to the connector terminal 5 by simply attaching the cover unit 30 to the wire connection section 20. Thus, the connection operation of connecting the wire 70 to the connector terminal 5 can be further simplified.

At that time, the core wire 71 is sandwiched and pressed between the pressing portion 34 and the bottom portion 21 of the wire connection section 20. Accordingly, the operation of pressing the core wire 71 and connecting the core wire 71 to the wire connection section 20 can be easily performed through the operation of attaching the cover unit 30 to the wire connection section 20 from above.

Each of the pair of wall portions (22A, 22B) of the wire connection section 20 includes a holding portion 26 that holds the core wire 71 when the cover unit 30 is attached to the wire connection section 20. Accordingly, when the cover unit 30 is attached to the wire connection section 20 and the core wire 71 is pressed against the wire connection section 20, the core wire 71 is held by the holding portions 26. Thus, the pressing operation is stabilized.

The connector 100 includes the above-described connector terminal 5 that can simplify the connection operation of connecting the wire 70. Thus, the manufacturing operation of the connector 100 is simplified.

### Other Embodiments

The present invention is not limited to the embodiment described and illustrated above, and, for example, the following embodiments also fall within the technical scope of the present invention.

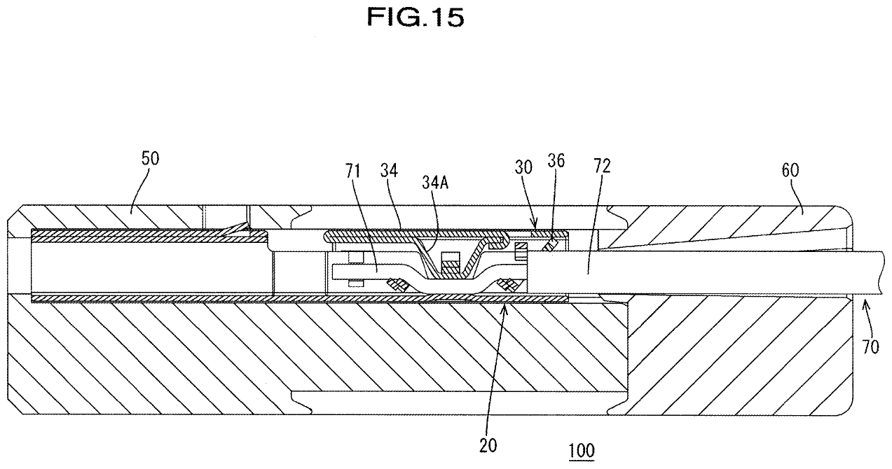

(1) The above-described embodiment has shown an example in which only the core wire 71 of the wire 70 is disposed in the connector terminal 5, as shown in FIG. 14 and so forth; however, the present invention is not limited thereto. As shown in FIG. 15, at least one of the wire connection section 20 and the cover unit 30 may be configured to include a clamping portion 36 that clamps the covering portion 72 of the wire 70. In this case, the wire 70, including the covering portion 72, can be disposed in the wire connection section 20 to which the cover unit 30 is attached. Note that FIG. 15 shows an example in which the cover unit includes the clamping portion 36.

### LIST OF REFERENCE NUMERALS

5 Connector terminal
10 Terminal main body unit
20 Wire connection section
21 Bottom portion
21A Raised part
22A, 22B Wall portion
23 Check portion
24 Locking portion
25 Locking portion
26 Holding portion
26A Corner part of holding portion
28 Terminal connection section
29 Opening
30 Cover unit
31A Window portion
33 Engagement portion
34 Pressing portion
34A Pressing protruding part
35 Deformation restricting portion
36 Clamping portion
50 Connector housing
60 Rear holder
70 Wire
71 Core wire
71A Protrusion of core wire
72 Covering portion
100 Connector

1. A connector terminal that is to be attached to a connector housing, the connector terminal comprising:
a terminal main body unit including a wire connection section that is to be electrically connected to a core wire of a wire; and
a cover unit configured to be attached to the wire connection section, and to cover the wire connection section,
wherein the wire connection section includes a locking portion configured to lock the cover unit, and
the cover unit includes
an engagement portion configured to be engaged with the locking portion so as to lock the cover unit to the wire connection section, and
a pressing portion configured to, in a state in which the engagement portion is engaged with the locking portion, sandwich and press the core wire of the wire between the pressing portion and the wire connection section.

2. The connector terminal according to claim 1,
wherein the pressing portion includes a pressing protruding part configured to form a protrusion by curving the core wire when the cover unit is attached to the wire connection section, and to press the protrusion against the wire connection section.

3. The connector terminal according to claim 2,
wherein the cover unit includes a deformation restricting portion configured to restrict deformation of the pressing protruding part when the pressing protruding part curves the core wire.

4. The connector terminal according to claim 1,
wherein the wire connection section includes
a bottom portion, and
a pair of wall portions that are opposed to each other standing upright from both edges of the bottom portion, and
the pressing portion sandwiches and presses the core wire between the pressing portion and the bottom portion of the wire connection section.

5. The connector terminal according to claim 4,
wherein the bottom portion of the wire connection section includes, at a position thereof opposed to the pressing portion of the cover unit, a raised part that is raised toward the pressing portion side.

6. The connector terminal according to claim 4,
wherein each of the pair of wall portions includes a holding portion configured to hold the core wire when the cover unit is attached to the wire connection section.

7. The connector terminal according to claim 6,
wherein the holding portions are formed between the pair of wall portions at positions that are displaced relative to each other.

8. The connector terminal according to claim 6,
wherein the holding portions each have a plate shape including a corner part, and
the holding portions hold the core wire with the corner parts.

9. The connector terminal according to claim 1,
wherein the wire connection section includes a check portion for checking electrical connection between the wire connection section and the core wire, and
the cover unit includes a window portion for exposing the check portion.

10. The connector terminal according to claim 1,
wherein the terminal main body unit includes a terminal connection section that is formed as a single piece with the wire connection section, and that is configured to be connected to a counterpart connector terminal, and,
in a state in which the cover unit is attached to the wire connection section, the wire connection section includes, between the terminal connection section and the cover unit, an opening for detecting the presence or absence of the core wire.

11. The connector terminal according to claim 1,
wherein the wire is a covered wire including a covering portion that covers the core wire, and
at least one of the wire connection section and the cover unit includes a clamping portion configured to clamp the covering portion.

12. A connector comprising:
the connector terminal according to claim 1; and
a connector housing into which the connector terminal is to be inserted.

13. The connector according to claim 12, comprising:
a rear holder configured to be attached to the connector housing, and including a wire insertion port into which the wire is to be inserted,
wherein the rear holder includes a wire insertion hole expanding toward the wire insertion port in a tapered shape.
